(19) United States
(12) Patent Application Publication
(10) Pub. No.: US 2023/0222873 A1
(43) Pub. Date: Jul. 13, 2023

(54) METHOD FOR PLAYING BLACKJACK WITH VARIOUS BETTING OPTIONS

(71) Applicant: STROPUS LTD., Agioi Omologites Nicosia (CY)

(72) Inventor: Artjoms SPIRIDONOVS, Agioi Omologites Nicosia (CY)

(21) Appl. No.: 18/000,896

(22) PCT Filed: Sep. 21, 2021
(86) PCT No.: PCT/IB2021/058576

§ 371 Date: Dec. 6, 2022

(51) Int. Cl. G07F 17/32; A63F 1/00

(52) U.S. Cl. CPC G07F 17/3262; A63F 1/00; G07F 17/3293; A63F 2001/003

(57) ABSTRACT

The present invention relates to method for playing blackjack with various betting options. A method for playing a card game allowing to place the bets during the game using last chance betting option and bet-in-play betting option. The last chance betting option allows to place a bet with a predetermined payout just before the round. The bet-in-play betting option becomes active during the round and amount of predetermined pay-out changes as the game progresses and combination of cards of the dealer changes. The method of the present invention allows t create a system in which the player does not lose the interest to the game until the last card is dealt.

### Field of the Invention

The present invention relates to method for playing blackjack with various betting options.

### Background of the Invention

Blackjack (formerly Black Jack and Vingt-Un) is the most widely played casino banking game in the world. The game is played with decks of 52 cards and is an American descendant of a global family of banking games known as Twenty-One. This family of card games also includes the British game of Pontoon and the European game, Vingt-et-Un. Blackjack players do not compete against each other. The game is a comparing card game where each player competes against the dealer.

The US patent publication No. U.S. Pat. No. 6,371,867 discloses a card game that combine the play of Blackjack (“21”) with a 3-card Poker wager or side bet (“21+3”). Each player places a basic Blackjack wager and an optional 3-card Poker wager before the cards are dealt. Each player is then dealt a card with the dealer receiving a face-up card. Each player is dealt a second card. At this point, the outcome of each 3-card Poker hand is determined, where a 3-card Poker hand consists of the 2-card hand dealt to that player and the dealer's face-up card. After settling the Poker wagers, the game of Blackjack continues in a typical fashion. Other similar methods of playing Blackjack are disclosed in the US patent application publications Nos. U.S. Pat. Nos. 5,257,810, 5,275,416 and US2016175694. Some of these methods offer side bets options.

The aim of the present invention is to design a method where the player does not lose the interest to the game until the last card is dealt.

### SUMMARY OF THE INVENTION

The aim is reached by a design of a method for playing blackjack with various betting options, like last chance betting option and/or bet-in-play options which are described in more detail bellow.

The method for playing a card game, comprising the steps of:

(a) placing a bet with a predetermined payout on a last chance betting option by a player;
(b) dealing two cards to the player and one card to a dealer;
(c) optionally dealing a hidden card to the dealer;
(d) bet-in-play option becomes active, wherein upon selection of the bet-in-play option by the player, the player can choose a chip and place a bet-in-play bet, and wherein a bet amount is indicated according to the placed bet-in-play bet with predetermined payout as set out in the next paragraphs;
(e) revealing a hidden card of the dealer if the hidden card was dealt in the step (b) or dealing a hidden card to the dealer if the hidden card was not dealt in the step (b) and revealing thereof;
(f) dealing a third card to the dealer if a hard score is 16 or less, or stop dealing a third card to the dealer if a hard score of the dealers' cards is 17 or more; and
(g) if the players' score is higher than the dealers' score, then the player is awarded according to the predetermined payout on a last chance betting option and/or predetermined payout of the bet-in-play.

The predetermined pay-out for the last chance betting option is selected from the following group:

Group A—last chance betting option placed before the round has started:
(ai) in a case of result of 777 suited cards the pay-out is 250:1;
(aii) in a case of result of 678 suited cards the pay-out is 125:1;
(aiii) in a case of result of 777 cards the pay-out is 25:1;
(aiv) in a case of result of 678 cards the pay-out is 15:1;
(av) in a case of result of 21 points of suited cards the pay-out is 5:1;
(avi) in a case of result of 21 points the pay-out is 2:1; and
(avii) in a case of result of any 20 or 19 points the pay-out is 0.5:1.

The predetermined pay-out for the bet-in-play betting option is selected from the following groups:

Group B—bet-in-play placed with “2” as the dealer's up card:
(bi) in a case of result of 21 points of suited cards the pay-out is 20:1;
(bii) in a case of result of 21 points the pay-out is 2:1; and
(biii) in a case of result of any 20 or 19 points the pay-out is 1:1.
Group C—bet-in-play placed with “3” as the dealer's up card:
(ci) in a case of result of 21 points of suited cards the pay-out is 20:1;
(cii) in a case of result of 21 points the pay-out is 2:1; and
(ciii) in a case of result of any 20 or 19 points the pay-out is 1:1.
Group D—bet-in-play placed with “4” as the dealer's up card:
(di) in a case of result of 21 points of suited cards the pay-out is 25:1;
(dii) in a case of result of 21 points the pay-out is 2:1; and
(diii) in a case of result of any 20 or 19 points the pay-out is 1:1.
Group E—bet-in-play placed with “5” as the dealer's up card:
(ei) in a case of result of 21 points of suited cards the pay-out is 30:1;
(eii) in a case of result of 21 points the pay-out is 2:1; and
(eiii) in a case of result of any 20 or 19 points the pay-out is 1:1.
Group F—bet-in-play placed with “6” as the dealer's up card:
(fi) in a case of result of 678 suited cards the pay-out is 40:1;
(fii) in a case of result of 678 cards the pay-out is 8:1;
(fiii) in a case of result of 21 points of suited cards the pay-out is 15:1;
(fiv) in a case of result of 21 points the pay-out is 3:1; and
(fv) in a case of result of any 20 or 19 points the pay-out is 1:1.
Group G—bet-in-play placed with “7” as the dealer's up card:
(gi) in a case of result of 777 suited cards the pay-out is 100:1;
(gii) in a case of result of 678 suited cards the pay-out is 40:1;
(giii) in a case of result of 777 cards the pay-out is 12:1;
(giv) in a case of result of 678 cards the pay-out is 8:1;
(gv) in a case of result of 21 points of suited cards the pay-out is 25:1;
(gvi) in a case of result of 21 points the pay-out is 5:1; and
(gvii) in a case of result of any 20 or 19 points the pay-out is 1:1.
Group H—bet-in-play placed with “8” as the dealer's up card:
(hi) in a case of result of 678 suited cards the pay-out is 40:1;
(hii) in a case of result of 678 cards the pay-out is 8:1;
(hiii) in a case of result of 21 points of suited cards the pay-out is 25:1;
(hiv) in a case of result of 21 points the pay-out is 5:1; and
(hv) in a case of result of any 20 or 19 points the pay-out is 1:1.
Group I—bet-in-play placed with “9” as the dealer's up card:
(xi) in a case of result of 21 points of suited cards the pay-out is 20:1;
(xii) in a case of result of 21 points the pay-out is 2:1; and
(xiii) in a case of result of any 20 or 19 points the pay-out is 0.5:1.
Group J—Bet in Play placed with “10” as the dealer's up card:
(ji) in a case of result of 21 points of suited cards the pay-out is 2.5:1;
(jii) in a case of result of 21 points the pay-out is 1:1; and
(jiii) in a case of result of any 20 or 19 points the pay-out is 0.5:1.
Group K—bet-in-play placed with Ace as the dealer's up card after Insurance has finished and
the dealer had no Blackjack:
(ki) in a case of result of 21 points of suited cards the pay-out is 25:1;
(kii) in a case of result of 21 points the pay-out is 3:1; and
(kiii) in a case of result of any 20 or 19 points the pay-out is 0.5:1.

Moreover, the player can select only one last chance betting option even if multiple seats are selected by the player.

The invention advantageously retains all the features and advantages of Blackjack as well as provides enhanced pay-out options.

The subject of the invention is a unique two-level side bet that allows the user to bet on the dealer's hand before the round (last chance betting option) and after the initial cards are dealt (bet-in-play betting option). It is possible to place the bet on both stages within the game. Bet-in-play betting option focuses on a concept that the player might lose the interest during the round in case of unsuccessful hand or decision and gives the player another chance to win in the Blackjack round. Compared to other existing side bets, there is an option for the player to place a bet up until the dealers hidden card is revealed and the option to bet is valid regardless of the initial dealer's card, and even in the case the player has busted his hand during the round. In such case the player still keeps a chance to win on the last chance side bet.

### BRIEF DESCRIPTION OF THE DRAWINGS

The drawings illustrate generally, by way of example, but not by way of limitation, various embodiments of the invention.

FIG. 1 illustrates an overall view of the playing interface with a casino type table (2) and a last chance betting option window (10).

FIG. 2 illustrates a playing surface or layout of a casino type table (2) in accordance with the invention.

FIG. 3 illustrates an inactive or not selected bet-in-play betting option window (10).

FIG. 4 illustrates active or selected bet-in-play betting option window (10).

FIG. 5 illustrates a chip placement example in the bet-in-play betting option window (10).

FIG. 6 illustrates a win message in the bet-in-play betting option window (10).

### DETAILED DESCRIPTION OF THE EMBODIMENTS

The preferred embodiments of the invention are now described with reference to the figures.

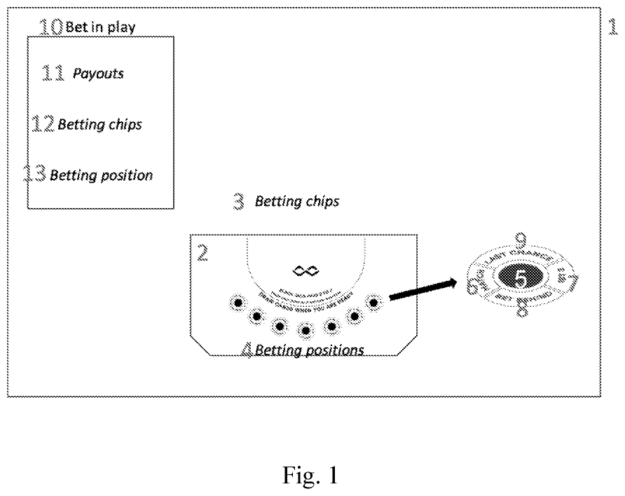

FIG. 1 illustrates an overall view of the playing interface (1) with a last chance betting option or position (9) and a bet-in-play betting option or position (10). In the following figure of a game interface a table (2) is displayed. The table (2) is where the player makes the bets and where the Blackjack cards are dealt. The interface also displays betting chips (3) arranged above the table (2). During the betting time the player selects betting chips (3) that has monetary value assigned. The table (2) comprises betting positions (4), wherein the player selects betting positions (4) on which the player wants to bet on. Each betting position (4) comprises a main betting position (5), where the player places main bet to participate in the game. The betting position (4) further comprises side bets (6; 7), which are bonus bets that have predefined combinations assigned depending on players' and dealers' cards, and a bet behind position (8), which is additional bet that allows other players to follow a main bet player. The invention is characterized in that each betting position (4) comprises a last chance side betting position (9). Upon selection of the last chance side betting position (9) the last chance betting option window opens and the player may place the bet before the round has started. The bet may be place on the following options: (ai) in a case of result of 777 suited cards the pay-out is 250:1; (aii) in a case of result of 678 suited cards the pay-out is 125:1; (aiii) in a case of result of 777 cards the pay-out is 25:1; (aiv) in a case of result of 678 cards the pay-out is 15:1; (av) in a case of result of 21 points of suited cards the pay-out is 5:1; (avi) in a case of result of 21 points the pay-out is 2:1; and (avii) in a case of result of any 20 or 19 points the pay-out is 0.5:1. Moreover, the invention is characterized in that it further comprises a bet-in-play betting option window (10) The bet-in-play betting option window (10) comprises the following interface features: bet in play payouts (11), betting chips (12) that has monetary value assigned and a selected chip (13) indicating which chip is selected for betting.

In addition, the player may be presented with video stream from dealers' studio. On the video the player can see studio, dealer, gaming table and equipment.

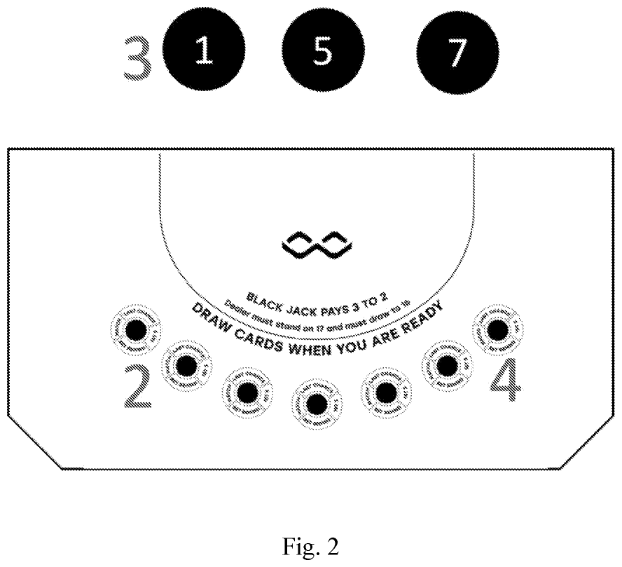

FIG. 2 illustrates a playing surface or layout of a casino type table (2) in accordance with the invention. The table (2) comprises seven betting positions (4). The betting chips (3) are located above the table (2). For each betting chip (3) a certain monetary value is assigned.

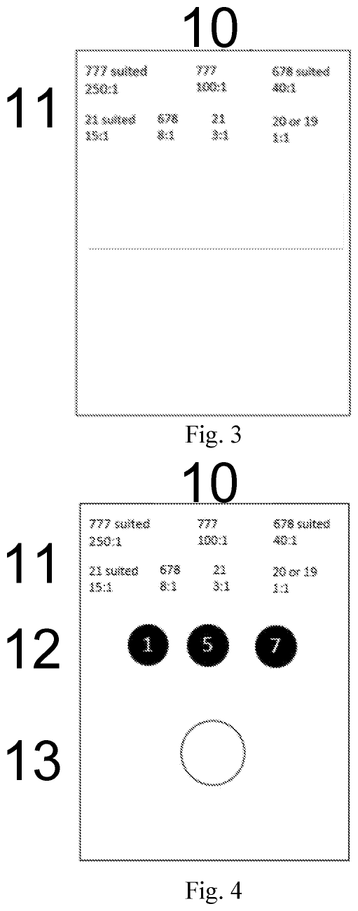

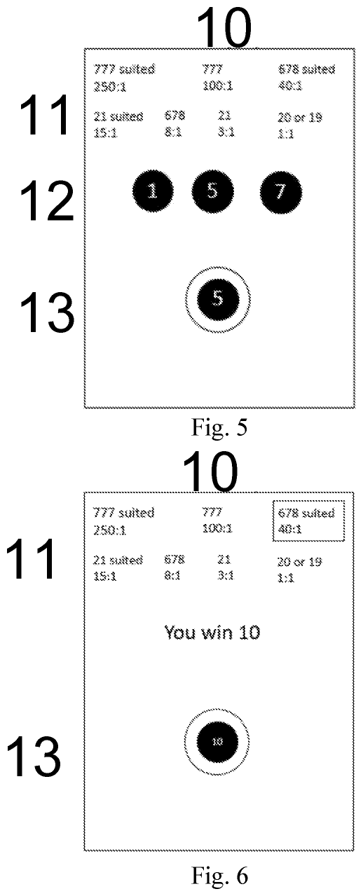

After initial cards are dealt the last chance betting option is closed. Further the player can place a bet on the bet-in-play betting position or window (10) throughout the active round payouts are changing based on the initial dealer card. During the round, the bet-in-play betting option window (10) is displayed, and new payouts (11) are appearing with overlay window. The player can see the updated payouts (11) and has a chance to select chips (12) and place an additional bet in the form of the selected chip (13). Bet is automatically confirmed once the player on last seat makes the decision. FIGS. 3 to 6 illustrate the bet-in-play betting option window (10) describing the bet-in-play process flow. FIG. 3 illustrates an inactive or not selected bet-in-play betting option window (10) showing actual payouts (11). FIG. 4 illustrates active or selected bet-in-play betting option window (10) showing not only the payouts (11), but also betting chips (12) to be selected by the player. The selected chip (13) position is empty as the player has not already selected any of available betting chips (12). FIG. 5 illustrates a selected chip (13) placement in the bet-in-play betting option window (10). FIG. 6 illustrates a win message in the last chance betting option window (10) as well as won amount in the selected chip (13) position. The amount to be won or the predetermined pay-out for the bet-in-play betting option is selected from the following groups:

Group B—bet-in-play placed with “2” as the dealer's up card:
(bi) in a case of result of 21 points of suited cards the pay-out is 20:1;
(bii) in a case of result of 21 points the pay-out is 2:1; and
(biii) in a case of result of any 20 or 19 points the pay-out is 1:1.
Group C—bet-in-play placed with “3” as the dealer's up card:
(ci) in a case of result of 21 points of suited cards the pay-out is 20:1;
(cii) in a case of result of 21 points the pay-out is 2:1; and
(ciii) in a case of result of any 20 or 19 points the pay-out is 1:1.
Group D—bet-in-play placed with “4” as the dealer's up card:
(di) in a case of result of 21 points of suited cards the pay-out is 25:1;
(dii) in a case of result of 21 points the pay-out is 2:1; and
(diii) in a case of result of any 20 or 19 points the pay-out is 1:1.
Group E—bet-in-play placed with “5” as the dealer's up card:
(ei) in a case of result of 21 points of suited cards the pay-out is 30:1;
(eii) in a case of result of 21 points the pay-out is 2:1; and
(eiii) in a case of result of any 20 or 19 points the pay-out is 1:1.
Group F—bet-in-play placed with “6” as the dealer's up card:
(fi) in a case of result of 678 suited cards the pay-out is 40:1;
(fii) in a case of result of 678 cards the pay-out is 8:1;
(fiii) in a case of result of 21 points of suited cards the pay-out is 15:1;
(fiv) in a case of result of 21 points the pay-out is 3:1; and
(fv) in a case of result of any 20 or 19 points the pay-out is 1:1.
Group G—bet-in-play placed with “7” as the dealer's up card:
(gi) in a case of result of 777 suited cards the pay-out is 100:1;
(gii) in a case of result of 678 suited cards the pay-out is 40:1;
(giii) in a case of result of 777 cards the pay-out is 12:1;
(giv) in a case of result of 678 cards the pay-out is 8:1;
(gv) in a case of result of 21 points of suited cards the pay-out is 25:1;
(gvi) in a case of result of 21 points the pay-out is 5:1; and
(gvii) in a case of result of any 20 or 19 points the pay-out is 1:1.
Group H—bet-in-play placed with “8” as the dealer's up card:
(hi) in a case of result of 678 suited cards the pay-out is 40:1;
(hii) in a case of result of 678 cards the pay-out is 8:1;
(hiii) in a case of result of 21 points of suited cards the pay-out is 25:1;
(hiv) in a case of result of 21 points the pay-out is 5:1; and
(hv) in a case of result of any 20 or 19 points the pay-out is 1:1.
Group I—bet-in-play placed with “9” as the dealer's up card:
(xi) in a case of result of 21 points of suited cards the pay-out is 20:1;
(xii) in a case of result of 21 points the pay-out is 2:1; and
(xiii) in a case of result of any 20 or 19 points the pay-out is 0.5:1.
Group J—Bet in Play placed with “10” as the dealer's up card:
(ji) in a case of result of 21 points of suited cards the pay-out is 2.5:1;
(jii) in a case of result of 21 points the pay-out is 1:1; and
(jiii) in a case of result of any 20 or 19 points the pay-out is 0.5:1.
Group K—bet-in-play placed with Ace as the dealer's up card after Insurance has finished and
the dealer had no Blackjack:
(ki) in a case of result of 21 points of suited cards the pay-out is 25:1;
(kii) in a case of result of 21 points the pay-out is 3:1; and
(kiii) in a case of result of any 20 or 19 points the pay-out is 0.5:1.

While the invention may be susceptible to various modifications and alternative forms, specific embodiments of which have been shown by way of example in the figures and have been described in detail herein, it should be understood that the invention is not intended to be limited to the particular forms disclosed. Rather, the invention includes all modifications, equivalents, and alternatives falling within the scope of the invention as defined by the following claims.

1. A method for playing a card game, comprising the steps of:
a. placing a bet with a predetermined payout on a last chance betting option by a player;
b. dealing two cards to the player and one card to a dealer;
c. optionally dealing a hidden card to the dealer;
d. bet-in-play option becomes active, wherein upon selection of the bet-in-play option by the player, the player can choose a chip and place a bet-in-play bet, and wherein a bet amount is indicated according to the placed bet-in-play bet with predetermined payout as set out in the next paragraphs;
e. revealing a hidden card of the dealer if the hidden card was dealt in the step (b) or dealing a hidden card to the dealer if the hidden card was not dealt in the step (b) and revealing thereof;
f. dealing a third card to the dealer if a hard score is 16 or less, or stop dealing a third card to the dealer if a hard score of the dealers' cards is 17 or more; and
g. if the players' score is higher than the dealers' score, then the player is awarded according to the predetermined payout on the last chance betting option and/or predetermined payout of the bet-in-play betting option.

2. The method according to claim 1, wherein the predetermined pay-out on the last chance betting option is selected from the following group:
(ai) in a case of result of 777 suited cards the pay-out is 250:1;
(aii) in a case of result of 678 suited cards the pay-out is 125:1;
(aiii) in a case of result of 777 cards the pay-out is 25:1;
(aiv) in a case of result of 678 cards the pay-out is 15:1;
(av) in a case of result of 21 points of suited cards the pay-out is 5:1;
(avi) in a case of result of 21 points the pay-out is 2:1; and
(avii) in a case of result of any 20 or 19 points the pay-out is 0.5:1.

3. The method according to claim 1, wherein the predetermined pay-out on the bet-in-play betting option with “2” as the dealer's up card is selected from the following group:
(bi) in a case of result of 21 points of suited cards the pay-out is 20:1;
(bii) in a case of result of 21 points the pay-out is 2:1; and
(biii) in a case of result of any 20 or 19 points the pay-out is 1:1.

4. The method according to claim 1, wherein the predetermined pay-out on the bet-in-play betting option with “3” as the dealer's up card is selected from the following group:
(ci) in a case of result of 21 points of suited cards the pay-out is 20:1;
(cii) in a case of result of 21 points the pay-out is 2:1; and
(ciii) in a case of result of any 20 or 19 points the pay-out is 1:1.

5. The method according to claim 1, wherein the predetermined pay-out on the bet-in-play betting option with “4” as the dealer's up card is selected from the following group:
(di) in a case of result of 21 points of suited cards the pay-out is 25:1;
(dii) in a case of result of 21 points the pay-out is 2:1; and
(diii) in a case of result of any 20 or 19 points the pay-out is 1:1.

6. The method according to claim 1, wherein the predetermined pay-out on the bet-in-play betting option with “5” as the dealer's up card is selected from the following group:
(ei) in a case of result of 21 points of suited cards the pay-out is 30:1;
(eii) in a case of result of 21 points the pay-out is 2:1; and
(eiii) in a case of result of any 20 or 19 points the pay-out is 1:1.

7. The method according to claim 1, wherein the predetermined pay-out on the bet-in-play betting option with “6” as the dealer's up card is selected from the following group:
(fi) in a case of result of 678 suited cards the pay-out is 40:1;
(fii) in a case of result of 678 cards the pay-out is 8:1;
(fiii) in a case of result of 21 points of suited cards the pay-out is 15:1;
(fiv) in a case of result of 21 points the pay-out is 3:1; and
(fv) in a case of result of any 20 or 19 points the pay-out is 1:1.

8. The method according to claim 1, wherein the predetermined pay-out on the bet-in-play betting option with “7” as the dealer's up card is selected from the following group:
(gi) in a case of result of 777 suited cards the pay-out is 100:1;
(gii) in a case of result of 678 suited cards the pay-out is 40:1;
(giii) in a case of result of 777 cards the pay-out is 12:1;
(giv) in a case of result of 678 cards the pay-out is 8:1;
(gv) in a case of result of 21 points of suited cards the pay-out is 25:1;
(gvi) in a case of result of 21 points the pay-out is 5:1; and
(gvii) in a case of result of any 20 or 19 points the pay-out is 1:1.

9. The method according to claim 1, wherein the predetermined pay-out on the bet-in-play betting option with “8” as the dealer's up card is selected from the following group:
(hi) in a case of result of 678 suited cards the pay-out is 40:1;
(hii) in a case of result of 678 cards the pay-out is 8:1;
(hiii) in a case of result of 21 points of suited cards the pay-out is 25:1;
(hiv) in a case of result of 21 points the pay-out is 5:1; and
(hv) in a case of result of any 20 or 19 points the pay-out is 1:1.

10. The method according to claim 1, wherein the predetermined pay-out on the bet-in-play betting option with “9” as the dealer's up card is selected from the following group:
(xi) in a case of result of 21 points of suited cards the pay-out is 20:1;
(xii) in a case of result of 21 points the pay-out is 2:1; and
(xiii) in a case of result of any 20 or 19 points the pay-out is 0.5:1.

11. The method according to claim 1, wherein the predetermined pay-out on the bet-in-play betting option with “10” as the dealer's up card is selected from the following group:
(ji) in a case of result of 21 points of suited cards the pay-out is 2.5:1;
(jii) in a case of result of 21 points the pay-out is 1:1; and
(jiii) in a case of result of any 20 or 19 points the pay-out is 0.5:1.

12. The method according to claim 1, wherein the predetermined pay-out on the bet-in-play betting option with Ace as the dealer's up card is selected after insurance has finished and the dealer had no Blackjack from the following group:
(ki) in a case of result of 21 points of suited cards the pay-out is 25:1;
(kii) in a case of result of 21 points the pay-out is 3:1; and
(kiii) in a case of result of any 20 or 19 points the pay-out is 0.5:1.

13. The method according to claim 1, wherein the player can select only one last chance betting option even if multiple seats are selected by the player.
